(19) United States
(12) Patent Application Publication
(10) Pub. No.: US 2002/0047523 A1
(43) Pub. Date: Apr. 25, 2002

(54) High-pressure discharge lamp

(76) Inventors: Mark Josephus Lucien Maria Van Dommelen, Turnhout (BE); Paulus Albertus Maria Vermeulen, Turnhout (BE)

Correspondence Address: U.S. Philips Corporation, 580 White Plains Road, Tarrytown, NY, 10591, US

(21) Appl. No.: 09/873,564

(22) Filed: Jun. 4, 2001

(30) Foreign Application Priority Data
Jun. 7, 2000 (EP) 00202009.7

(51) Int. Cl. H01J 61/35; H01K 1/34

(52) U.S. Cl. 313/635; 313/25; 313/479

(57) ABSTRACT

The invention relates to a high-pressure discharge lamp provided with a discharge vessel. The discharge vessel is enveloped with clearance by an outer bulb having a cap. According to the invention, the outer bulb is translucent and substantially tubular in shape.

The invention relates to a high-pressure discharge lamp comprising a discharge vessel which is enveloped with clearance by an outer bulb provided with a lamp cap, which outer bulb is translucent.

A lamp of the type mentioned in the opening paragraph is commonly known and finds wide application, for example, in public lighting. The outer bulb of the known lamp is shaped like an ovoid or another convex, for example like a paraboloid of revolution. The outer bulb may be provided at an end portion with a dimple or a dome providing a support for the discharge vessel. In this manner, a diffuse light source is obtained. A drawback of the known lamp resides in that it is comparatively voluminous. This additionally leads to relatively large dimensions of an armature wherein the lamp can be used, which adversely affects the light-focusing possibilities.

It is an object of the invention to provide a means for counteracting said drawbacks. To achieve this, a lamp of the type mentioned in the opening paragraph is characterized, as a lamp in accordance with the invention, in that the outer bulb is substantially tubular in shape.

It has surprisingly been found that a substantially tubular outer bulb does not only lead to a smaller volume of the lamp but also to a higher light output of the lamp in a luminaire that is suitable for the known lamp, without the beam distribution being adversely affected. As a result, the lamp in accordance with the invention can very suitably replace the known lamp.

Preferably, the outer bulb is provided with a light-scattering layer. This has the advantage that the strength of the outer bulb is not adversely affected, as is the case when a surface of the outer bulb itself is rendered diffusely scattering, for example, by means of sandblasting. It is particularly suitable if the outer bulb of the lamp in accordance with the invention is covered with a light-scattering layer which forms an electrostatic coating. An electrostatic coating process is comparatively simple and can suitably be employed in industrial-scale batch production processes. It has surprisingly been found that a uniform coating on a substantially tubular body can be achieved already by displacing a spray source in the longitudinal direction of the tubular body in the course of the coating process. Such an adaptation of the production process can be carried out in a very simple manner and has a negligibly small influence on the cost of the production process. Although the invention leads to a higher thermal load on the coating as compared to the known lamp, it has been found that this has no adverse effects on the service life of the lamp.

The invention can very suitably be applied in high-pressure sodium lamps. These lamps are employed in very large numbers in, inter alia, public lighting and lighting of halls, such as sports halls. In such applications, uniform lighting of comparatively high intensity is very important. The use of a diffuse light source is very helpful in this respect, which, in addition, helps to avoid dazzle.

These and other aspects of the lamp in accordance with the invention will be apparent from and elucidated with reference to the embodiment(s) described hereinafter.

In the drawings:

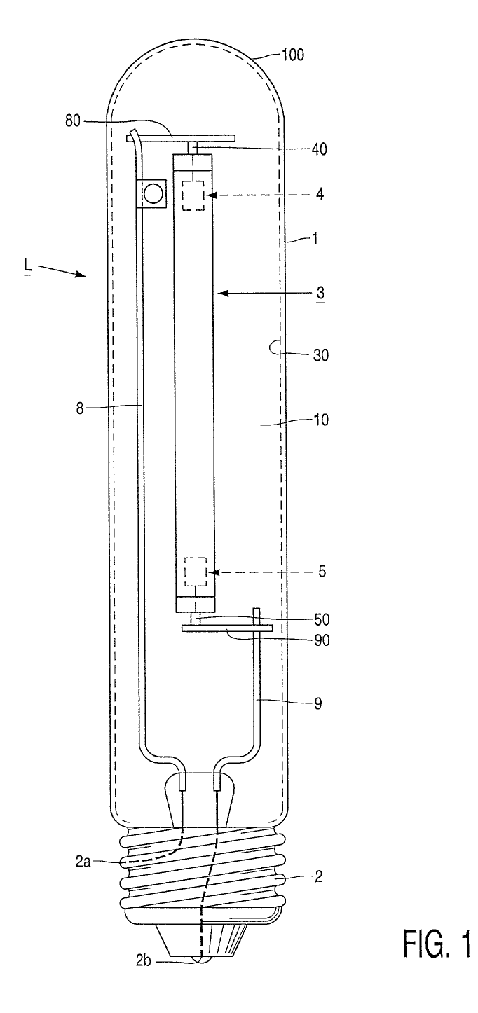

FIG. 1 is a view of a lamp in accordance with the invention, and

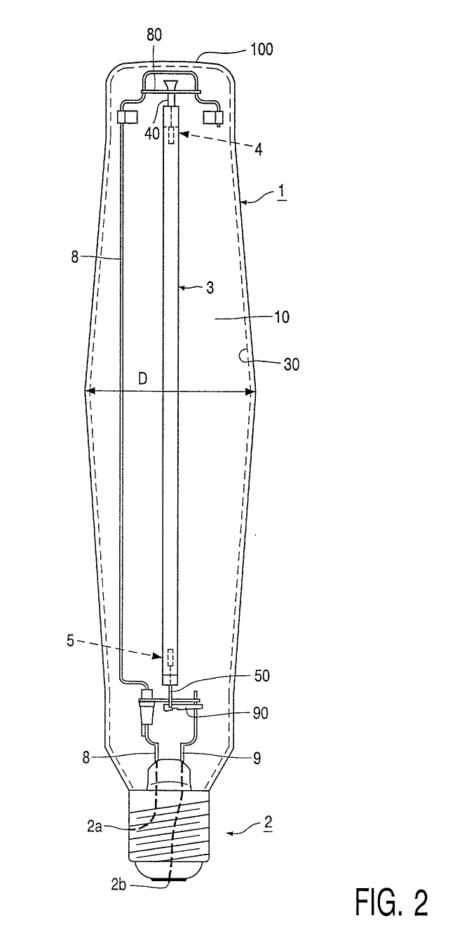

FIG. 2 is a modification of the lamp in accordance with the invention.

FIG. 1 shows a high-pressure discharge lamp L comprising a discharge vessel 3 which is enveloped with clearance 10 by an outer bulb 1 provided with a lamp cap 2. The discharge vessel 3 is provided with inner electrodes 4, 5 between which a discharge extends when the lamp is in operation. Electrode 4 is electrically connected to a contact point 2a of the lamp cap 2 by means of a feed-though element 40 and conductors 80, 8. Electrode 5 is similarly connected to a contact point 2b of the lamp cap 2 by means of a feed-through element 50 and conductors 90, 9. The outer bulb is substantially tubular and provided, at a first end, with a dome-shaped closure 100. The lamp cap forms a seal at an other end of the outer bulb. The outer bulb is internally provided with a light-scattering layer in the form of an electrostatic coating 30.

In a practical embodiment of the lamp described herein, said lamp is a high-pressure sodium lamp having a rated power of 150 W. The outer bulb of the lamp, which is provided with an internal electrostatic coating, has a diameter of 46 mm. For comparison, a known lamp of the same rated power has a maximum external dimension of the ovoid outer bulb in a plane transverse to the longitudinal direction of the discharge vessel of 90.8 mm. The coating is composed of 90% Ca₂P₂O₇ and 10% SiO_{2.}

The lamp in accordance with the invention generates a luminous flux of 12,900 lm. If the lamp in accordance with the invention is employed in an existing luminaire, intended for a lamp with an ovoid outer bulb, then the efficiency of the luminaire is 75.4%. The luminaire efficiency is defined as the percentage of lamp-generated light issuing from the luminaire. For comparison, use is made of an existing 150 W lamp having a coated, translucent ovoid outer bulb. This lamp, which generates a luminous flux of 15,130 lm, leads to a luminaire efficiency of 74% when it is used in the same luminaire. The distribution of the total luminous flux over the beam width of the light issuing from the luminaire is the same in both cases. Consequently, if the known lamp is substituted with the lamp in accordance with the invention, a substantial improvement in luminaire efficiency is obtained.

The variant of the lamp in accordance with the invention is shown in FIG. 2, wherein corresponding parts bear the same reference numeral. Halfway its length, the outer bulb has a largest diameter D. At the location of the closure at the first end and near the lamp cap, the diameter is 0.75 times that of the diameter D.

1. A high-pressure discharge lamp (L) comprising a discharge vessel (3) which is enveloped with clearance (10) by an outer bulb (1) provided with a lamp cap (2), which outer bulb is translucent, characterized in that the outer bulb is substantially tubular in shape.

2. A lamp as claimed in claim 1, characterized in that the outer bulb is provided with a light-scattering layer (30).

3. A lamp as claimed in claim 2, characterized in that the light-scattering layer forms an electrostatic coating.
